(19) United States
(12) Patent Application Publication
(10) Pub. No.: US 2001/0004794 A1
(43) Pub. Date: Jun. 28, 2001

(54) Incremental swaging of sleeve to cylindrical workpiece

(76) Inventor: Viraraghavan S. Kumar, Palm Bay, FL (US)

Correspondence Address: Charles E. Wands, Esq., ALLEN, DYER, DOPPELT, MILBRATH & GILCHRIST, Post Office Box 3791, Orlando, FL, 32802-3791, US

(21) Appl. No.: 09/756,403

(22) Filed: Jan. 8, 2001

Related U.S. Application Data
(63) Continuation of application No. 09/326,912, filed on Jun. 7, 1999.

(51) Int. Cl. B23P 11/00

(52) U.S. Cl. 29/505; 29/515

(57) ABSTRACT

An incremental swaging process securely affixes a sleeve, such as a metal ring, to the external surface of a cylindrically workpiece, such as a hollow configured metallic casing. Successive portions of the sleeve are incrementally swaged by a tooling element whose tooling surface dimension is less than the axial dimension of the sleeve. During relative rotation between the tooling element and the casing upon which the sleeve has been place, the tooling element is incrementally brought into and out of mechanical engagement with axially adjacent and overlapping surface regions of the sleeve. This incremental swaging technique results in very tightly swaging axially successive annular portions of the sleeve against axially successive, annular surface portions of the rotating casing, leaving the sleeve very securely affixed to the casing. A preferred embodiment uses a commercial multi-spindle machine tool, which allows interior and exterior surfaces of the casing to be pre-machined on one spindle in preparation for the incremental swaging of the sleeve, and then the pre-machined casing is transferred to a second spindle for receiving and incrementally swaging the sleeve, followed by shaping the composite structure.

### FIELD OF THE INVENTION

The present invention relates in general to the machining and assembly of materials, such as malleable metallic components, and is particularly directed to a new and improved swaging technique for incrementally securely affixing a sleeve member, such as a ring of swageable metal, to the external surf ace of a workpiece or body blank, such as a hollow cylindrical metallic casing, and the shaping of resultant composite swaged structure.

### BACKGROUND OF THE INVENTION

The production, assembly and shaping of components into a finished, precision-dimensioned product that is intended for use in extreme environments, or is to be exposed to very severe mechanical forces, typically require that the resulting composite structure be capable of withstanding potentially destructive stresses. In the case of a multi-component and shaped composite structure, such as a shaped cylindrical metallic casing of the type shown in the perspective view of FIG. 1, the outer contour of a cylindrical body blank 10 may be readily built up by initially friction-fitting one or more rings or sleeves 12 made of machine tool-shapeable metal to the external surface 11 of the casing, and then swaging the ring 12 onto the body blank 10, to realize a composite structure. Once the outer sleeve has been rigidly attached to the body blank, the composite structure can be shaped by using a machining tool (lathe) to selectively remove metal and realize the precise contour of the product.

Swaging of the sleeve 12 onto the outer surface of the body blank 10 has conventionally been accomplished by using a first machine tool to initially abrade or roughen that portion 13 of the surface 11 of the casing 10 where the ring 12 is to be attached (to prevent axial movement during swaging). The thus prepared body blank is then physically removed from the abrading tool and transferred to a separate swaging machine. A ring/sleeve is then placed over the abraded region of the body blank, and the swaging machine is operated so as to crimp or ‘squeeze’ the sleeve onto the casing. Unfortunately, it has been found that composite structures that have been assembled and shaped using standard swage-crimping often fail when tested during an extended period of production due to the swaging tool wear.

### SUMMARY OF THE INVENTION

Pursuant to the present invention, the potential for failure of composite structures assembled by such conventional crimp-based sleeve swaging is effectively obviated by a new and improved swaging technique, through which successive, narrow band-like portions of the sleeve are incrementally swaged by means of one or more tooling elements (e.g., tapered wheels) whose tooling surface dimensions are less than the axial dimension of the ring. In particular, during relative rotation between the tooling element and a cylindrical workpiece upon which the sleeve has been placed, the tooling elements are incrementally translated or stepped along the axis of the spindle. At each stepped location, they are brought into and out of mechanical engagement with axially adjacent and overlapping surface regions of the rotating sleeve, so that relatively narrow, axially successive, annular surface portions of the sleeve are caused to conform with and thereby be retained in tight compression against the discontinuous shape of the knurled surface of the rotating workpiece.

This incremental conformal swaging of the invention is in contrast with the more generally applied crimping action of a conventional swaging machine. In a conventional swaging machine, a single swaging force is applied across the entirety of sleeve, which can cause the geometry of the crimped sleeve to be non-conformal with the undulating surface of the body blank, leading to the potential for gaps or a substantially reduced compression bond between the swaged sleeve and the workpiece. This poor adhesion of a conventional crimp may allow the swaged sleeve to translate or shift along the surface of the casing, when subjected to prescribed axial forces, so that the composite casing is unable to maintain a very strictly defined configuration and comply with or surpass prescribed strength parameters the crimp will supposedly withstand.

In a non-limiting, but preferred embodiment of the invention, advantage is taken of the functionality of a commercially available, multi-spindle machine tool, which allows both exterior and interior pre-machining of the body blank to be carried out on one spindle in preparation for the incremental swaging of the sleeve on a second spindle; there is no need to transfer the components from one machine to another, as in the case of a conventional crimp-based swage machine. Once it has been pre-machined on the first spindle, the body blank is transferred to the second spindle, to receive the sleeve. The sleeve is then incrementally swaged on the second spindle, followed by shaping the composite sleeve-workpiece structure. This ability to use a single machine to perform all the steps of the invention offers a significant savings in time and cost of production over the prior art.

### BRIEF DESCRIPTION OF THE DRAWINGS

FIG. 1 is a perspective view diagrammatically illustrating a cylindrical casing upon which a sleeve is swaged;

FIG. 2 diagrammatically shows a generally cylindrical metallic casing retained on a first lathe spindle for pre-machining;

FIG. 3 diagrammatically shows a pre-machined casing transferred to a second lathe spindle for incremental sleeve swaging;

FIG. 4 shows a tapered swaging wheel;

FIGS. 5-7 diagrammatically show successive steps of the incremental- swaging process of the invention;

FIG. 8 shows the manner in which successive incremental swaging engagement of the swaging wheel of FIG. 4 against the outer surface of a rotating sleeve overlaps an immediately previous swaged annular sub-portion of the sleeve; and

FIG. 9 diagrammatically illustrates the use of a machining tool to shape an incrementally swaged sleeve and body blank composite structure.

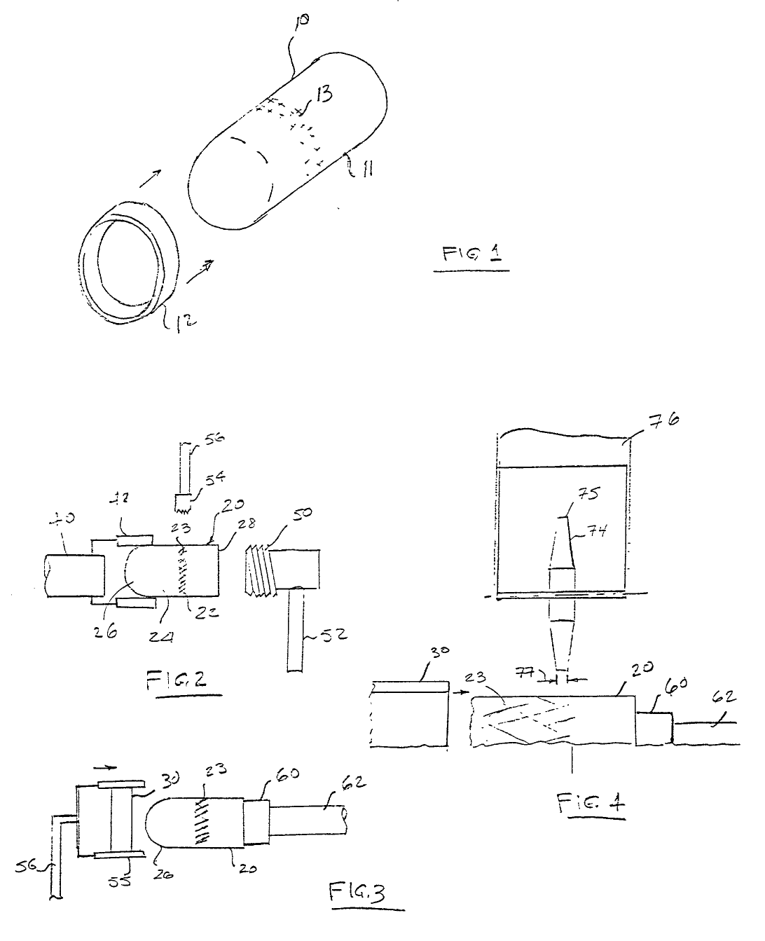

### DETAILED DESCRIPTION

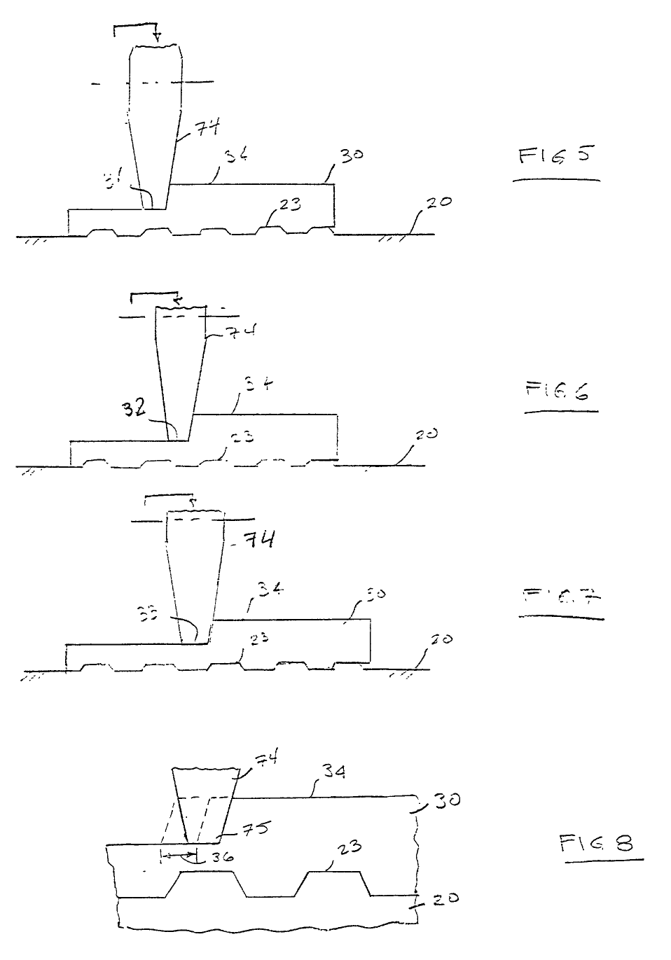

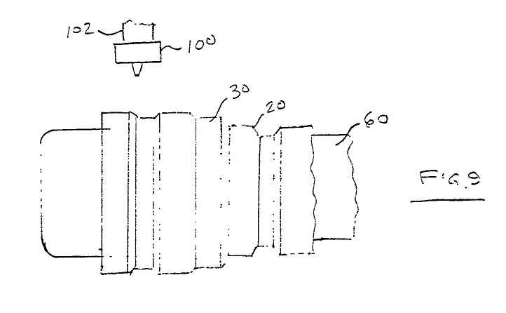

Attention is now directed to FIGS. 2-8 of the drawings, which diagrammatically illustrate the steps of the incremental swaging process according to the present invention. As pointed out above, pursuant to a non-limiting, but preferred embodiment, all of the steps of the invention may be readily carried out on a single commercially available, multi-spindle machine tool, such as a Nakamura-Tome Model TW-10 twin spindle precision multi-axis computer controlled lathe, available from Nakamura-Tome America, Inc. This provides the invention with significant savings in time and cost of production. As described briefly above, a dual spindle machine configuration readily allows a workpiece to be pre-machined on one spindle, and then transferred to the second spindle for further machining, while the first spindle is being reloaded with a new workpiece. In FIGS. 3 and 4, the hardware configuration of such a twin spindle lathe is shown in a simplified diagrammatic format, in order to avoid cluttering the drawings with details of the lathe, per se, which are not necessary for an understanding of the invention, and to focus instead on the manner in which the incremental swaging technique is carried out.

As shown in FIG. 2, a first step in the process of the invention involves pre-machining a workpiece in the form of a generally cylindrical metallic (e.g. steel) body blank or casing 20 in preparation for receiving and swaging a generally annular shaped malleable (metallic - copper) sleeve or ring at a prescribed region 22 of the outer surface 24 of the casing 20. For this purpose, a first (e.g., closed) end portion 26 of the casing 20 is retained on a first controllably rotational lathe spindle 40 by means of a spindle collet 42. During rotation of the first spindle during the pre-machining step, an interior bore machining tool 50, mounted to a multi-axis translatable tool arm 52, may be used to define the interior configuration (e.g., thread formation) of a second (hollow) end portion 28 of the body blank/casing 20, as the casing is controllably rotated on the first spindle 40. Similarly, an exterior surface abrading or knurling tool 54 mounted to a multi-axis translatable tool arm 56, may be brought into engagement with the exterior surface of the spindle-rotated casing 20, so as to form a discontinuous or knurled surface region or band 23 on the exterior surface region 22 of the casing where the sleeve is to be attached.

Once the body blank 20 has been pre-machined on the first spindle in preparation for receiving and swaging the sleeve, it is transferred to and secured at a second spindle station, shown in FIG. 3 as comprising a chuck 60 mounted to a second controllably rotational lathe spindle 62. At the second spindle station, the (copper) sleeve 30 as retained by a collet 55 of a multi-axis tool arm 56 may then be placed over the first end portion 26 of the pre-machined body blank (mounted to the chuck 60) and into non-slip frictional engagement with the knurled exterior surface region 23 of the body blank. Once it has been retained in a generally non-slip condition by the abraded surface of the casing 20, the sleeve 30 is ready to be incrementally swaged onto the casing.

For this purpose, as shown in FIG. 4, one or more swaging tooling elements, in the form of one or more tapered wheels 74, may be free-wheel mounted to a multi-axis translatable tool arm 76 adjacent to the second lathe spindle 60. A respective tooling wheel 74 may be tapered to a generally cylindrical or disc-shaped tooling surface 75 having an axial dimension or width 77 that is preferably less than the axial dimension of a discontinuity in the abraded surface region or band 23 on the body blank. As noted earlier, this reduced axial width of the sleeve engaging surface 75 of a tooling wheel 74 serves to increase the swaging pressure against the sleeve, and thereby ensures that each successive swaged surface region of the rotating sleeve 30 will conform with and be retained in tight compression against the discontinuous shape of the knurled surface of the rotating body blank 20.

As shown in FIGS. 5-7, for each axially offset swaging step, once the tool arm has axially translated along the axis of second lathe spindle to a new incremental swaging location, it is sequentially moved toward and away from the spindle, so that the one or more tooling wheels 74 are brought into and out of engagement with plural axially successive, overlapping portions 31, 32, 33, . . . , of the outer surface 34 of the sleeve 30. At each respective incremental swaging engagement of the tooling surface of the swaging wheel(s) 72 against the outer surface 34 of the spindle rotated sleeve 30, a successive annular sub-portion of the sleeve 30 will be swaged against a sub-portion of the knurled surface region 23 of the body blank.

As shown in FIG. 8, since each successive incremental swaging engagement of the swaging wheel's tooling surface 75 against the outer surface 34 of the rotating sleeve 30 overlaps the immediately previous swaged annular sub-portion 36 of the sleeve, axially successive interior stepped wall surface portions of the sleeve 30 are incrementally tightly compressed against axially successive annular portions of the knurled surface region 23 of the casing 20, leaving the entire sleeve 30 securely conformal with and swaged into the confines of the abraded surface of the casing. Once the sleeve 30 has been incrementally swaged onto the casing 20 in the manner described above, the resulting composite structure, as retained on the second lathe spindle 60, may be further shaped as shown in FIG. 9, by means of an additional machining tool 100 mounted to an associated multi-axis translatable tool arm 102.

As pointed out above, unlike a composite shaped casing structure made by the conventional broad application crimp-based technique of the prior art, which often fails when tested, it has been found that the surface-conforming, incremental swaging process of the invention prevents the sleeve from translating along the surface of the casing, when subjected to axial forces in excess of those mandated for crimp based swaging. As a result, a composite ring-casing structure made by the process of the invention is able to maintain a very strictly defined shape that complies with or surpasses industry standard strength parameters. Moreover, by using a single, multi-spindle machine to perform all the steps of swaging process, the invention is able to provide significant savings in time and cost of production over a conventional process which uses separate machines for shaping and swaging.

While I have shown and described an embodiment in accordance with the present invention, it is to be understood that the same is not limited thereto but is susceptible to numerous changes and modifications as known to a person skilled in the art, and I therefore do not wish to be limited to the details shown and described herein but intend to cover all such changes and modifications as are obvious to one of ordinary skill in the art.

What is claimed:

1. A method of securing a generally ring-shaped sleeve member to a generally cylindrically configured workpiece comprising the steps of:
(a) placing said generally ring-shaped sleeve member at a prescribed surface region of said generally cylindrically configured workpiece;
(b) providing a first tooling element having a tooling surface dimension that is less than an axial dimension of said generally ring-shaped sleeve member;
(c) effecting relative rotation between said first tooling element and said generally cylindrically configured workpiece; and
(d) effecting incremental engagement between said tooling surface of said first tooling element and successive annular regions of said generally ring-shaped sleeve member during relative rotation between said first tooling element and said generally cylindrically configured workpiece, so as to incrementally swage successive annular portions of said generally ring-shaped sleeve member against successive, annular portions of said prescribed surface region of said generally cylindrically configured workpiece, and thereby affix said generally ring-shaped sleeve member to said generally cylindrically configured workpiece.

2. A method according to claim 1, wherein step (d) comprises incrementally bringing said tooling surface of said first tooling element into engagement against successive, overlapping annular regions of said generally ring-shaped sleeve member, during relative rotation between said first tooling element and said generally cylindrically configured workpiece, so as to incrementally swage said successive annular portions of said generally ring-shaped sleeve member against successive, annular portions of said prescribed surface region of said generally cylindrically configured workpiece, and thereby affix said generally ring-shaped sleeve member to said generally cylindrically configured workpiece.

3. A method according to claim 1, wherein step (d) comprises, during relative rotation between said first tooling element and said generally cylindrically configured workpiece upon which said generally ring-shaped sleeve member has been placed, incrementally bringing said first tooling element into and out of mechanical engagement with axially adjacent and overlapping surface regions of said generally ring-shaped sleeve member.

4. A method according to claim 1, wherein said prescribed surface region of said generally cylindrically configured workpiece has a generally knurled surface contour.

5. A method according to claim 1, wherein step (a) comprises the steps of:
(a1) rotating said generally cylindrically configured workpiece by means of a first spindle, while causing engagement between a tooling surface of a second tooling element and said prescribed surface region of said generally cylindrically configured workpiece, and thereby form a generally knurled surface contour in said prescribed surface region of said generally cylindrically configured workpiece,
(a2) transferring said generally cylindrically configured workpiece to a second spindle, and
(a3) bringing said generally ring-shaped sleeve member into engagement with said generally knurled surface contour of said prescribed surface region of said generally cylindrically configured workpiece as retained by said second spindle.

6. A method according to claim 5, wherein step (c) comprises effecting rotation of said second spindle upon which said generally cylindrically configured workpiece is retained, and step (d) comprises bringing said first tooling element into engagement with said successive, overlapping annular regions of said generally ring-shaped sleeve member, so as to mechanically swage said successive annular portions of said generally ring-shaped sleeve member against said successive annular portions of said prescribed surface region of said generally cylindrically configured workpiece, and thereby affix said generally ring-shaped sleeve member to said generally cylindrically configured workpiece.

7. A method according to claim 1, further comprising the steps of:
(e) shaping said generally cylindrically configured workpiece and said generally ring-shaped sleeve member that has been securely affixed thereto in step (d).

8. A method according to claim 1, wherein said first tooling element comprises a wheel with a generally cylindrical tooling surface having an axial dimension less than the axial dimension of said ring-shaped sleeve member.

9. A method according to claim 1, wherein steps (a)-(d) are carried out on a single multi-spindle lathe apparatus.

10. A composite structure comprising a generally cylindrically configured member, and a generally ring-shaped sleeve member positioned upon a prescribed outer surface region of said generally cylindrically configured member, and having immediately successive annular sub-portions thereof individually swaged against immediately successive annular sub-regions of said prescribed outer surface region of said generally cylindrically configured member.
